(19) United States
(12) Patent Application Publication
(10) Pub. No.: US 2017/0339261 A1
(43) Pub. Date: Nov. 23, 2017

(54) CURVED SCREEN PROTECTOR

(71) Applicant: MING-TA CHIANG, Taipei City (TW)

(72) Inventor: MING-TA CHIANG, Taipei City (TW)

(21) Appl. No.: 15/159,243

(22) Filed: May 19, 2016

(51) Int. Cl. H04M 1/02

(52) U.S. Cl. CPC H04M 1/0266

(57) ABSTRACT

A curved screen protector includes a transparent layer to protect the planar area of the curved screen. A curved frame is disposed to the and transparent layer to cover the curved area of the curved screen. Therefore, the curved screen may be well protection to significantly reduce the chance of the damage on the screen edges caused by the undesired forces.

### BACKGROUND OF THE INVENTION

### Field of Invention

The present invention relates to a protector, and more particularly, but not exclusively to a curved screen protector to be applied to a 2.5D cured screen.

### Related Art

With the development and progress of electronics and semiconductor technology, the mobile devices and the wearable devices are very popular, such as Notebook computers, Tablet computers, Phablets, Smart phones, Smart watches, and Smart bracelets. These devices are usually equipped with planar touch screens. Due to long-time touch and touch for control, the touch screen may be wear or damage. Therefore, the soft or hard protection film is used to protect the screen form wear or damage during usage or carry, and maintain the well appearance and display quality.

For the hard protection film, it is multi-layer laminated structure. A silicone layer is provided on a polyethyleneterephthalate (PET) substrate firstly. Then, the PET substrate is die-cut to a plurality of smaller substrate. The smaller PET substrate is disposed to a surface of a hard film by optically clear adhesive (OCA) to form the multi-layer laminated structure. With the development and progress of display technology, the screen is designed to non-planar 2.5D curved screen to improve vision, good appearance, and increase display area with limited area. Therefore, the screen protector has to be redesigned for the 2.5D curved screen.

Comparing with the hard protection film for the planar screen, the manufacture process of the hard protection film for the curved screen has to be controlled strictly the tolerance and the deformation for each laminate to make sure the quality of the fitness. The production yields would be decreased and the the manufacture costs would be higher. Therefore, there is a need to enhance the strength of the curved screen protector of the communication device with lower costs, high-yield production, simplified process and well protection.

### SUMMARY OF THE INVENTION

The present invention overcomes the above-described and other problems and disadvantages in the prior art by providing a curved screen protector to avoid damage on the screen edges caused by the undesired forces.

Accordingly, the present invention provides a curved screen protector, to protect the planar area of the curved screen by the transparent layer, and to cover the curved area of the curved screen by the curved frame. Therefore, the curved screen may be well protection to significantly reduce the chance of the damage on the screen edges caused by the undesired forces.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is exploded view of the curved screen protector of the present invention;

FIG. 2 is schematic view of the curved screen protector of the present invention;

FIG. 3 is cross-sectional view of the curved screen protector of the present invention;

FIG. 4 is schematic view of the curved screen protector of the present invention when in use and assembled to a communication device; and

FIG. 5 is cross-sectional view of the curved screen protector of the present invention when in use and assembled to a communication device.

### DETAILED DESCRIPTION OF THE INVENTION

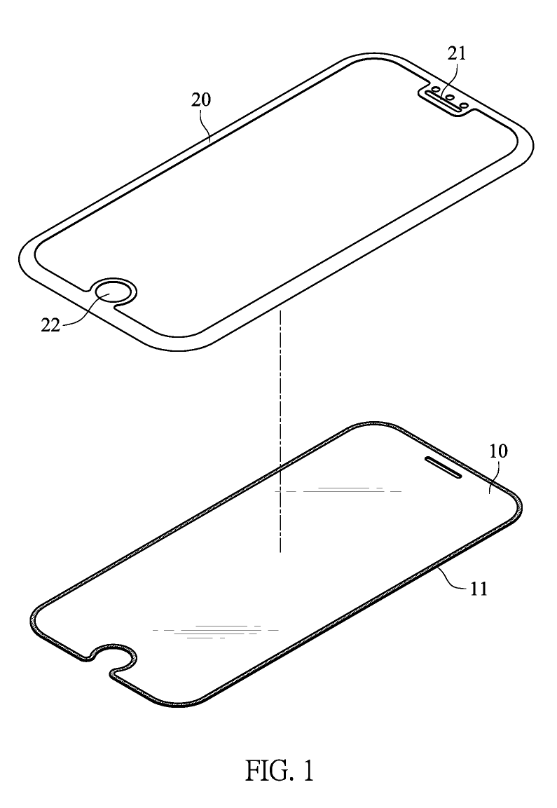

Please refer to FIG. 1, a exploded view of the curved screen protector of the present invention is shown.

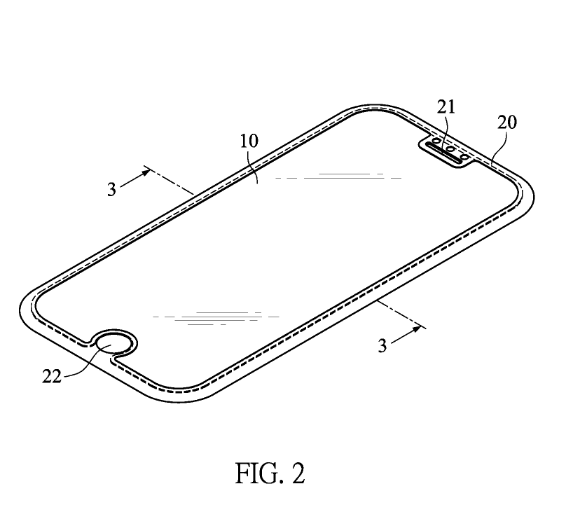

The curved screen protector of the present invention includes a transparent layer 10 and a curved frame 20. The transparent layer 10 has an adhesion layer 11 at the periphery thereabove. The curved frame 20 further has a speaker aperture 21 and a control aperture 22 to corresponding to the communication device. As shown in FIG. 2, the curved frame 20 is disposed on the periphery of the transparent layer 10 through the adhesion layer 11. FIG. 2 is schematic view of the curved screen protector of the present invention.

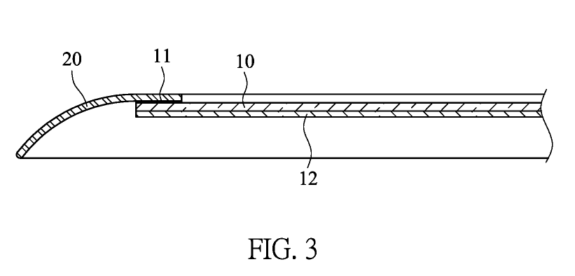

FIG. 3 is cross-sectional view of the curved screen protector of the present invention. The curved frame 20 is disposed on the periphery of the transparent layer 10 through the adhesion layer 11. The adhesion layer 11 is an UV(Ultraviolet)-curable adhesive film to improve the joint strength between the transparent layer 10 and the curved frame 20. The transparent layer 10 further has a adhering layer 12 to adhere to the screen of the communication device. The adhering layer 12 may be an UV(Ultraviolet)-curable adhesive film, a polyethyleneterephthalate (PET) film, or a silicone film. The transparent layer 10 is a tempered glass film to enhance the protection for the screen and to improve the appearance. The curved frame 20 is made of metal to enhance the structural strength.

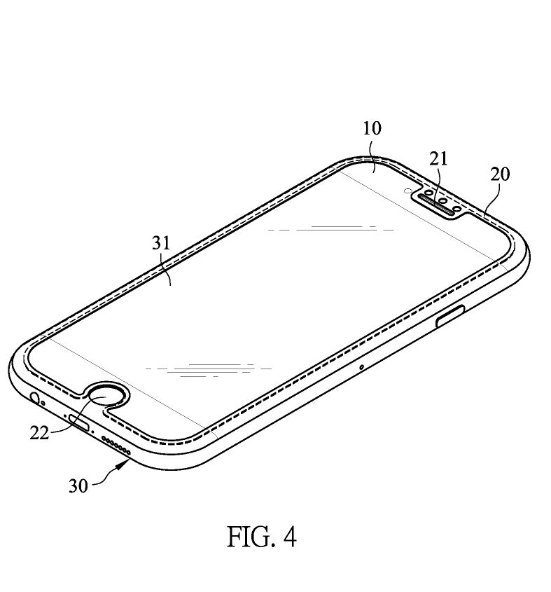

FIG. 4 is schematic view of the curved screen protector of the present invention when in use and assembled to a communication device.

The curved screen protector of the present invention includes a transparent layer 10 and a curved frame 20. The curved frame 20 has a speaker aperture 21 and a control aperture 22 to corresponding to the communication device 30. The curved frame 20 can optionally include one or more aperture(s) therethrough to allow a user to operate controls of the communication device 30, for camera operation, and/or for transmission of sound to/from a microphone and/or speaker of the communication device 30. As shown, the communication device 30 has a 2.5D curved screen 31. The curved screen 31 includes a planar area 311 and a curved area 312 at the edges. The periphery of the curved screen 31 is covered by the curved frame 20.

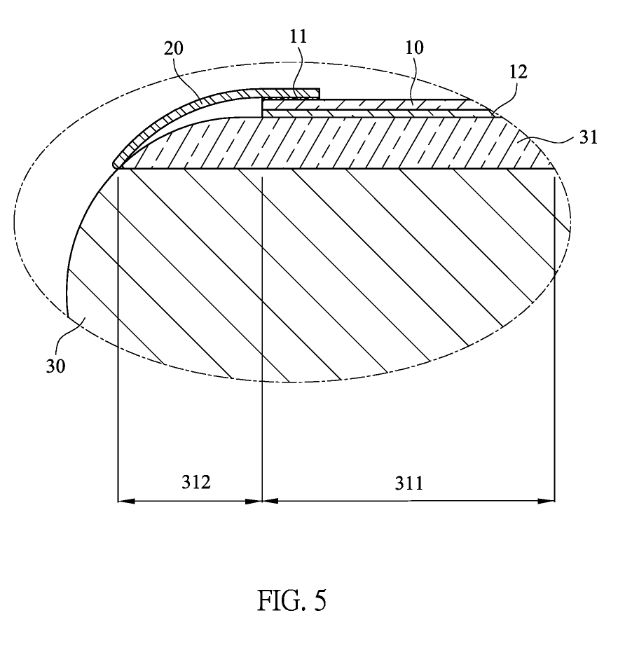

The transparent layer 10 has an adhesion layer 11 at the periphery thereabove. Therefore, the curved frame 20 is disposed on the periphery of the transparent layer 10 through the adhesion layer 11. The transparent layer 10 further has the adhering layer 12 to adhere to the planar area 311 of the curved screen 31. It is not easy to be bent to cover the curved area 312 of the curved screen 31 by the transparent layer 10 due to the material property. The curved area 312 of the curved screen 31 is covered by the curved frame 20 to avoid damage on the screen edges caused by the undesired forces. Please also see FIG. 5, which is cross-sectional view of the curved screen protector of the present invention when in use and assembled to the communication device.

Accordingly, the present invention provides a curved screen protector to protect the planar area of the curved screen by the transparent layer, and to cover the curved area of the curved screen by the curved frame with lower costs, high-yield production, simplified process and well protection.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A curved screen protector, the curved screen including a planar area and a curved area, the curved screen protector comprising:
a transparent layer, disposed on the planar area of the curved screen and having an adhesion layer at the periphery thereabove; and
a curved frame, disposed on the periphery of the transparent layer through the adhesion layer and covering the curved area of the curved screen.

2. The curved screen protector of claim 1, wherein the transparent layer is a tempered glass film.

3. The curved screen protector of claim 1, wherein the adhesion layer is an UV(Ultraviolet)-curable adhesive film.

4. The curved screen protector of claim 1, wherein the transparent layer further has a adhering layer between the transparent layer and the planar area of the curved screen to be adhered thereon.

5. The curved screen protector of claim 4, wherein the adhering layer is an UV(Ultraviolet)-curable adhesive film, a polyethyleneterephthalate (PET) film, or a silicone film.

6. The curved screen protector of claim 1, wherein the curved frame is made of metal.

7. The curved screen protector of claim 1, wherein the curved frame further has a speaker aperture.

8. The curved screen protector of claim 1, wherein the curved frame further has a control aperture.
